(19) United States
(12) Patent Application Publication
(10) Pub. No.: US 2026/0011153 A1
(43) Pub. Date: Jan. 8, 2026

(54) METHOD FOR EVALUATING AND/OR IMPROVING A TOTAL DEPTH MAP OF A MONITORING AREA AND TOTAL DEPTH MAP ARRANGEMENT FOR IMPLEMENTING THE METHOD

(71) Applicant: Robert Bosch GmbH, Stuttgart (DE)

(72) Inventors: Moritz M. Knorr, Hildesheim (DE); Florian Richter, Lamspringe (DE); Emil Schreiber, Hannover (DE); Christian Neumann, Hildesheim (DE)

(21) Appl. No.: 19/259,582

(22) Filed: Jul. 3, 2025

(30) Foreign Application Priority Data
Jul. 5, 2024 (DE) 10 2024 206 367.3

(51) Int. Cl. G06V 20/52; G06T 3/40; G06T 7/20; G06V 20/64

(52) U.S. Cl. CPC G06V 20/52; G06T 3/40; G06T 7/20; G06V 20/64; G06T 2207/30241

(57) ABSTRACT

A method for evaluating and/or improving a total depth map of a monitoring area, wherein the total depth map of the monitoring area is provided, wherein at least one object is detected in the monitoring area, wherein the total depth map is evaluated and/or improved based on the detected object.

### BACKGROUND

The invention relates to a method for evaluating and/or improving a total depth map of a monitoring area and a total depth map arrangement for implementing the method.

Camera surveillance systems are used to monitor public or private places with the aid of cameras. It is possible to move the cameras or to enlarge certain portions. In the field of technical image processing, but also in the context of surveillance, depth information from the monitored regions is also used. In this way, the two-dimensional monitoring area is transformed into a three-dimensional monitoring area.

U.S. Pat. No. 10,346,996 B2 discloses techniques and systems for determining image depth from semantic labels. In one or more implementations, a digital media environment includes one or more computing devices to control a determination of depth within an image. Regions of the image are semantically labeled by the one or more computing devices. At least one of the semantically labeled regions is decomposed into a plurality of segments formed as planes that are generally perpendicular to a base surface of the image. The depth of one or more of the plurality of segments is then derived based on the relationships between the respective segments and the respective positions on the base surface of the image. A depth map is created that describes the depth for the at least one semantically labeled region based at least in part on the derived depths for the one or more segments of the plurality of segments.

### SUMMARY

The invention relates to a method for evaluating and/or improving a total depth map of a monitoring area, a total depth map arrangement, a computer program, and a computer readable data carrier having the features of the disclosure. Preferred advantageous embodiments of the invention are shown in the disclosure, the following description and the accompanying Figures.

The invention relates to a method for evaluating and/or improving a total depth map of a monitoring area.

The monitoring area may be located in a commercial, private and/or public region. The monitoring area may be configured to be contiguous, alternatively it may be configured to be partially contiguous or segmented with open intermediate areas between the segments.

A total depth map with depth information of the monitoring area is provided. The total depth map may be configured as a matrix, wherein the depth information is encoded in the matrix points. In terms of data technology, the depth information is encoded in the same way as color information in an image, in particular configured as a raster graphic. For example, the depth information is encoded in gray levels, wherein the gray levels correspond to a depth. The ‘depth’ is configured in particular as a radial clearance, i.e. a radial distance to the camera, or an actual or conventional depth (in the narrower sense), i.e. a clearance in the main viewing direction of the camera. Both clearance indications (radial or along only one axis/depth (in the narrower sense)) are common in the literature. However, the clearance along only one axis is usually specified. The total depth map is configured in particular as a scaled total depth map, in which the depth information is coded in absolute values, e.g. in meters.

The total depth map may also be configured as a 3D point cloud, 3D map, a voxel grid or 2D elevation map or 3D mesh. In particular, the total depth map may be the result of the representation of a plurality of depth maps in a common coordinate system. In this case, the depth information is entered in the common coordinate system.

At least one object is detected in the monitoring area. Preferably, a plurality of monitoring cameras is arranged in the monitoring area. In particular, more than five monitoring cameras, especially more than ten monitoring cameras, are arranged in the monitoring area. The monitoring cameras may be configured as stationary cameras. Alternatively, they are realized as mobile and/or movable cameras, such as PTZ cameras. In a very small version, only one or two monitoring cameras may be arranged in the monitoring area.

In particular, the object is configured as a mobile and/or moving object. Detection may be carried out using digital image processing or AI, for example. In particular, an object position is additionally detected.

In the context of the invention, it is proposed that the total depth map is evaluated and/or improved based on the detected object, in particular the object position. During an evaluation, it is checked in particular whether the detected object, in particular the object position, and the total depth map plausibly match. In principle, it can be assumed that the detected object lies on a base surface of the total depth map. In the event that the detected object is lifted off the base surface and is therefore ‘floating in the air’, it can be assumed that the total depth map is not correct at the corresponding object position.

Alternatively or additionally, the total depth map may be improved based on the detected object, for example by varying the base surface for the aforementioned case in such a way that the detected object, in particular at the object position, rests on the base surface. In particular, when improving the total depth map, individual points or individual regions are changed, while other individual points or individual regions remain unchanged. In particular, the improvements are configured as local improvements in the total depth map and not as global improvements. In particular, the total depth map is improved only or at least significantly at the object position.

It is a consideration of the invention that the detected object moves quasi as a sensing element over the monitoring area and in this way scans the monitoring area. The scan can be recorded and used for evaluating and/or improving the total depth map.

It is particularly preferred that object recognition of the detected object is carried out. After object recognition, at least the object class of the detected object is known. The object class may, for example, be configured as a vehicle, in particular a bus, passenger car, truck, bicycle, motorcycle, person, animal, etc. Object recognition may be performed, for example, by pattern matching as part of digital image processing and/or using AI.

Object information may be estimated, in particular determined, based on the object class. The object information provides a further basis, in particular a-priori knowledge, such as the object size or an object orientation, for evaluating and/or improving the total depth map.

By knowing the object class, for example, a typical object size or—in the event that the exact object type, such as vehicle type, etc., is known—an exact object size can be inferred, wherein the total depth map can be evaluated and/or improved knowing the exact object size of the detected object.

Knowing the object size, for example, a clearance from the object to the monitoring camera with which the underlying image was captured can be inferred. This clearance can be compared with the depth information in the total depth map in order to evaluate and, if necessary, to improve it. It is assumed that the monitoring camera is arranged in the common coordinate system of the total depth map in terms of data technology or that the clearance can at least be represented in the common coordinate system.

The object alignment of the object allows direct conclusions to be drawn about the local plane normal in the total depth map so that this can be evaluated and/or improved.

In a preferred concretization, the detected object may be recognized as a person as an object class, wherein person information is estimated as object information. Typically, the person is assumed to be approximately 1.80 m tall, and an object orientation, i.e. a person's orientation, can also be estimated. Based on this object information, the total depth map can be evaluated and/or improved.

Alternatively or additionally, the detected object is recognized as a vehicle as an object class. In this case, vehicle information is estimated, in particular determined, as object information. In particular, it is possible to recognize a specific vehicle type or a vehicle model, wherein very exact vehicle information on the vehicle type or vehicle model is available from databases, for example. Furthermore, it is particularly easy to determine the object orientation of vehicles, for example as driving orientation or driving direction. The total depth map can be evaluated and/or improved on the basis of this vehicle information.

It is particularly preferable to derive a polyhedron for the detected and/or recognized object. The polyhedron represents the object, wherein the total depth map is evaluated and/or improved based on the polyhedron. The object position preferably corresponds to the polyhedron position. By using polyhedra, the detected and/or recognized object can be processed particularly easily in terms of data technology.

In particular, coordinates are derived from images of the monitoring area, which define projected corner points of a polyhedron in the respective image. The coordinates are configured in particular as image coordinates and/or as 2D coordinates and represent points in the image on or in the image plane. In particular, eight corner points are determined, which define six side surfaces (front, back, top, bottom, left, right for vehicles in the direction of travel). Depending on the geometry of the object, right angles do not necessarily have to be present. However, the polyhedron preferably encloses the object in such a way that neither parts of the object protrude beyond the polyhedron, nor that it is too large and there is a ‘gap’ between the polyhedron and the object. In particular, the polyhedron is configured with six side surfaces, in particular as a cuboid and especially preferably as a rectangular cuboid. The polyhedron represents the object.

Based on the polyhedron, a polyhedron position may be defined as the object position. The polyhedron position may be, for example, a center of gravity or a center of gravity or center point of the polyhedron projected onto the base surface, preferably the polyhedron position is configured as a corner point, center point or base point of the polyhedron.

In addition, an object alignment of the object, in particular of the vehicle, is derived from the image. In particular, the image is used to derive where the front side and where the rear side of the object is, in particular in relation to the polyhedron. The combination of the object alignment and the polyhedron position may optionally be referred to as the pose of the polyhedron and/or the object. The use of the polyhedron in conjunction with vehicles as objects is particularly advantageous.

A further consideration is that the detection of the coordinates of the projected corner points of the polyhedron is independent of the specific object type and may therefore be used in a wide range of cases. It is also simpler in terms of data technology to process only the pose of a polyhedron and not to use a large number of support points of the object.

In a preferred realization of the invention, the coordinates of the polyhedron are configured as p3D coordinates. These are the projection of the eight (3D) corner points of the object-enclosing polyhedron into the image. Such p3D coordinates can be easily derived from the image using a variety of methods.

As a frame projection, the p3D coordinates are the projection into the image of a polyhedron (imagined in the real world) directly surrounding the object, in particular a cuboid, configured as a 3D frame. The 3D frame and/or the polyhedron is formed in particular by straight line segments. ‘Directly surrounding’ is to be understood as meaning that a surface defined by the imaginary 3D frame or polyhedron (e.g. polyhedron defined by the frame) surrounds the object as tightly/closely as possible, for example with the smallest possible volume. The respective surfaces and edges of the surface spanned by the 3D frame or the polyhedron touch the surface of the object. In other words, a so-called ‘3D-bounding box’ is determined in particular as a 3D frame or polyhedron. The 3D frame is an enveloping body, preferably in the form of a rectangular cuboid.

In a preferred further development of the invention, a trajectory of the detected object is detected in the monitoring area. In particular, the detected object moves along the trajectory in the monitoring area, wherein interpolation points of the trajectory have different time stamps, in particular continuous time stamps. It is provided that the total depth map is evaluated and/or improved based on the detected trajectory of the object. While a single detection of the object may already be a basis for evaluating and/or improving the total depth map, the detection of a trajectory of the object provides a further basis for evaluating and/or improving the total depth map: like this, it can be assumed that the object cannot make any sudden changes in height along the trajectory, so that the individual interpolation points of the trajectory are more meaningful if they run along a plausible trajectory.

In a preferred embodiment, an uncertainty map is generated as an evaluation, wherein evaluation results of the total depth map based on the detected object are displayed in the uncertainty map. For example, a positive evaluation result may be entered if the detected object is compatible and/or plausible with the total depth map. For example, the detected object is located on a base surface in the total depth map. For example, a negative evaluation result may be entered if the detected object is incompatible and/or implausible with the total depth map. For example, the detected object is at a distance from a base surface in the total depth map (‘floating in the air’). For example, a neutral evaluation result may be entered if sub-areas of the total depth map could not yet be evaluated with a detected object.

In an alternative or further development, an inconsistency map is generated as an evaluation, wherein inconsistent regions of the total depth map are displayed in the inconsistency map. Such inconsistent regions may be formed, for example, if the detected object travels along the trajectory through a base surface in the total depth map or exhibits other implausible behavior.

In an alternative or further development, a limitation map is generated as an evaluation, wherein height jumps and/or mechanical limitations of the total depth map are displayed in the limitation map. Mechanical limitations may, for example, be configured as roadway limitations. By using a large number of detected objects and in particular their trajectories, the limitation map can be created in a very meaningful way.

In a preferred further development, the total depth map is fused in a fusion step with image information, in particular color information, of the images of the monitoring area in a joint visualization model of the monitoring area. Through the knowledge of the total depth map, the joint visualization model can be constructed and enriched with image information, in particular color information, so that the result is a 2D model or 3D model as a visualization model of the monitoring area.

The visualization model and thus the monitoring area may, for example, be displayed and/or monitored by surveillance personnel via corresponding output devices. The uncertainty map, the inconsistency map and/or the limitation map may be displayed so that the monitoring area and the significance of the total depth map may be understood intuitively and easily.

Alternatively, the uncertainty map, the inconsistency map and/or the limitation map may be fed back into the evaluating and/or improving module in order to improve the total depth map based on this data.

A further consideration is that the classic division of the images from the monitoring cameras into different screens is not intuitively tangible for surveillance personnel. This form of display therefore has clear disadvantages, since it requires surveillance personnel to be familiar with the structure of the camera system and the monitoring area under observation in order to be able to spatially classify the monitoring sub-areas shown and to have an understanding of which regions are not being monitored in order to understand where, for example, a person who is no longer visible may have gone. However, this problem is exacerbated if, for example, a service provider who looks after several of a customer's buildings connects to the video system of a monitoring area in order to investigate an alarm, for example. In this case, it cannot be assumed that the operator is familiar with the system or the monitoring area.

The method creates a 3D representation of the monitoring area that is much more intuitive to understand and also offers a number of new options that a classic representation does not allow or only allows with difficulty. The aim/result is therefore that larger, connected camera networks are displayed in a single merged view.

In a concretization for providing the total depth map in the monitoring area, the plurality of monitoring cameras is arranged, wherein each monitoring camera may capture an image from a monitoring sub-area of the respective monitoring camera.

Some or all of the monitoring sub-areas mapped in the respective image may be configured to overlap. The monitoring cameras may also capture multiple images, in particular the monitoring cameras may capture image sequences or streams comprising a plurality of images.

In a depth recognition step, a depth map with depth information of the monitoring sub-area is created for each of the images of the monitoring cameras. The depth map may be configured as a matrix, wherein the depth information is encoded in the matrix points. In terms of data technology, the depth information is encoded in the same way as color information in a or in the image, is in particular configured as a raster graphic. In particular, the resolution of the depth map corresponds to the resolution of the underlying image.

The depth information is unscaled in the depth recognition step and/or is configured as relative information in the depth map. In particular, the depth information is not represented metrically, for example in meters etc., but in unscaled values.

In a scaling step, the plurality of depth maps is scaled for a common coordinate system and is merged into the total depth map. The common coordinate system may, for example, be configured as a world coordinate system. It may be provided that the common coordinate system is configured as a common relative coordinate system, so that a common relative scaling is implemented in the scaling step. Preferably, the common coordinate system is configured as a common absolute coordinate system, which is metrically scaled, so that the depth information or other distances for the absolute coordinate system are metric, for example in meters, etc.

In a preferred embodiment of the invention, the depth map or the depth maps are implemented in the depth recognition step using a method for monocular depth estimation (Mono-Depth). A wide range of such methods are publicly available. In particular, this is an AI method.

In principle, the depth recognition step and the scaling step may be implemented in a common step and/or in a common AI, so that the depth information is available in absolute, metric quantities or in relative quantities in the common coordinate system. An example of this is: ‘ZoeDepth: Zero-shot Transfer by Combining Relative and Metric Depth’ (https://arxiv.org/abs/2302.12288). This network predicates (theoretically) metric (correct) outputs. In practice, however, it has been found that the indications are too imprecise for the present case of application and rescaling is required. Further examples are the image processing of Telsa or ‘Lift, Splat, Shoot: Encoding Images From Arbitrary Camera Rigs by Implicitly Unprojecting to 3D’ (https://arxiv.org/abs/2008.05711). Here, however, some very strong assumptions are made about the environment or always the same/similar camera views. As a result, these methods probably generalize very poorly to a monitoring camera scenario.

In a preferred realization of the invention, the individual depth maps are intermediately stored as an intermediate result. The intermediate storage may take place on a temporary or permanent storage medium. Thus, the depth maps are completely available before the scaling step. This realization underlines the fact that the depth recognition step and scaling step are not implemented in a joint step and/or in a joint AI. Instead, the advantages and accuracy of a method for creating an unscaled depth map are utilized first, followed by the advantages of a method for scaling the unscaled depth map.

In a preferred embodiment of the invention, the scaling is performed based on at least one scaling information. The scaling information has an information content that enables scaling of the depth maps. In particular, it is information selected from intrinsic camera parameters of at least one monitoring camera, extrinsic camera parameters (in particular a location) of at least two monitoring cameras with overlapping monitoring sub-areas and/or overlap information of monitoring sub-areas.

By dividing the method into the depth recognition step and the scaling step with the scaling information, the visualization model can be created particularly accurately. Methods for relative depth recognition are very accurate and lead to reliable recognition results. By using scaling information in the scaling step, the relative scaling of the individual depth maps can be transferred very accurately and reliably to the common coordinate system, so that the basis for the common visualization model is very reliable and leads to a meaningful and high-quality visualization model. In particular, scaling is performed in metric units, such as meters.

Typically, several camera views are required for 3D reconstruction/depth estimation. In the present case, it is proposed to estimate the depth map from one image at a time. AI-based methods are proposed for implementation, such as Vision Transformers for Dense Prediction (DPT), which estimate the depth information from a single image. Of course, these methods are typically not as accurate as methods based on multiple cameras. Some of these mono-depth methods also estimate an absolute depth/distance. However, this is very challenging and therefore error-prone, since the method has to distinguish, for example, between a telephoto view of a vehicle and a wide-angle view of the same vehicle. In both cases, the vehicle could appear the same size in the image, but the camera could be over a hundred meters away in the case of a telephoto camera and only a few meters away in the case of the wide-angle camera.

Methods such as the proposed DPT therefore take a different approach and estimate an ‘unscaled’ depth without direct metric meaning. The region estimated as the closest point in the depth image is shown as e.g. white (maximum value) and the point estimated as the furthest away is shown as e.g. black (minimum value). In other words, distances or depths are simply indicated between the limitations ‘closest’ and ‘furthest away’. The scaling in between typically corresponds to an inverse depth as depth information, since the method is often trained based on stereo data and the inverse depth corresponds to a disparity.

A possible implementation of DPT may be downloaded from https://github.com/isl-org/DPT. The publication Vision Transformers for Dense Prediction: René Ranftl, Alexey Bochkovskiy, Vladlen Koltun (arXiv: 2103.13413) contains a theoretical description for implementing the method, downloadable from: https://arxiv.org/pdf/2103.13413.pdf.

For a meaningful application, the depth (relative or absolute, in particular metric) for the common coordinate system has to be recovered when using the method with ‘non-metric’ depths. This is implemented in the scaling step based on the scaling information. In order to convert the depth maps (e.g. from DPT) into a true/metric or relative scale in the common coordinate system, two values may typically be determined, an absolute offset and a scaling factor. Depending on the method, there may be more, fewer or other parameters. In principle, if one of the monitoring cameras has a scaled depth map that has been scaled using the scaling information, the scaling may be transferred to another monitoring camera that has an overlapping monitoring sub-area. This is achieved by

In a preferred further development of the invention, the scaling information comprises extrinsic and/or intrinsic camera parameters.

The extrinsic camera parameters may, for example, be configured as positions of the monitoring cameras in the common coordinate system. As far as the monitoring sub-areas of the monitoring cameras with known position overlap, the scaling can be implemented based on this scaling information.

The intrinsic camera parameters, such as a focal length of the monitoring camera, can be used to scale the depth map of the image from the monitoring camera with the known focal length. If the intrinsic camera parameters of only one monitoring camera are known and the monitoring sub-areas of the other monitoring cameras overlap with the monitoring sub-area of the monitoring camera with the known focal length, the scaling can be transferred to the images of the other monitoring cameras.

Alternatively or additionally, the scaling information may be determined by an additional measuring device or by at least one monitoring camera as a measuring device. For example, a laser scanner may be used, which measures absolute distances to objects in the monitoring sub-area as scaling information, wherein the absolute distances are assigned to the corresponding regions in the depth maps in the scaling step, whereby the depth map is scaled by the assignment. It may also be provided that a known measurement body is positioned in the monitoring sub-area, wherein the depth map is scaled by detecting the measurement body with the monitoring camera and knowing the dimensions of the known measurement body. The measurement body may also be a vehicle that happens to be present in the monitoring sub-area or a person with known or usual dimensions.

In a preferred embodiment of the invention, a ground plane of the monitoring area or of the monitoring sub-area is determined in the image and/or in the depth map. The determination may be made, for example, by semantic segmentation, known from digital image processing. By adding the scaling information, such as a known calibration, extrinsic and/or intrinsic camera parameters, the position of the monitoring camera relative to the ground plane is known, so that the ground plane in the image and/or in the depth map can be scaled. In the event that the monitoring sub-areas have a common ground plane and the monitoring sub-areas overlap, the scaling can be performed without further information. The scaled ground plane thus forms the or a derived scaling information in the scaling step.

It is therefore proposed to use the scaled ground plane as scaling information. The ground plane should preferably be determined automatically or semi-automatically in order to simplify the setup for the user. For example, a semantic segmentation may be used, which may optionally be determined by DPT. All image regions recognized as ‘road’ are assumed to be ground planes. By adding a known (extrinsic) calibration, the position of the camera in relation to the ground plane is known. By comparing the depth values in the ‘road’ region with the expected depth values based on the plane assumption, for example, the two unknown parameters can be determined and the depth map can be scaled.

For a particularly simple implementation, it is proposed that the depth map has map points with depth information, wherein the map points correspond to the image points in the associated image or correspond to them, i.e. are configured as correspondence points. Thus, the map points with the depth information form a point cloud, which is transferred to the common coordinate system as the total depth map via the scaling step. Due to the correspondence of the map points to the image points, the point cloud of the map points can be easily enriched with color information from the images in the fusion step.

In a preferred further development of the invention, the visualization model can, for example, be displayed via a 3D screen, wherein a user or the surveillance personnel may move in the visualization model via a virtual camera. Alternatively or additionally, the visualization model may be displayed via VR glasses, wherein the user or the surveillance personnel may change their own view by moving their head. It is also possible for one or more virtual cameras to be defined, wherein the field of view of the virtual cameras is displayed on several screens or screen sections. This has the advantage that the virtual cameras may be used to define fields of view that are intuitively understandable for the user and/or the surveillance personnel.

A further object of the invention is formed by a total depth map arrangement, which is configured in particular for implementing the method as described above. The total depth map arrangement is configured in particular as a digital data processing device, such as a computer, a server or a cloud. The total depth map arrangement comprises an interface for transferring the total depth map and/or images from the monitoring cameras. The images each show a monitoring sub-area of the monitoring area. Optionally, the total depth map arrangement comprises the plurality of monitoring cameras arranged in the monitoring area. Alternatively, the total depth map arrangement comprises the images of the monitoring sub-areas of the monitoring area.

The total depth map arrangement comprises a detection module for detecting at least one object in the monitoring area and an evaluating and/or improving module for evaluating and/or improving the total depth map based on the at least one detected object.

The total depth map arrangement optionally comprises a depth recognition module, which is configured for the depth recognition step. Furthermore, the total depth map arrangement comprises a scaling module, which is configured for the scaling step. In addition, the total depth map arrangement optionally comprises a fusion module, which is configured to implement the fusion step.

Optionally, the total depth map arrangement has an output device which is configured to output, in particular visualize, the visualization model. The output device may, for example, be configured as a 3-D screen, VR glasses or a screen for displaying fields of view of virtual cameras in the visualization model.

A further object of the invention is provided by a computer program comprising instructions which, when the program is executed by a computer or the visualization device, cause it to execute the method/steps of the method according to the invention. A further object of the invention is formed by a computer-readable, in particular non-volatile, data carrier on which the computer program is stored.

### BRIEF DESCRIPTION OF THE DRAWINGS

Further features, advantages and effects of the invention are apparent from the following description of preferred configuration examples and the accompanying Figures. These show:

FIG. 1 shows a schematic block diagram of a total depth map arrangement in general form as a configuration example of the invention;

FIG. 2 shows a schematic block diagram of a total depth map device in general form for the total depth map arrangement in FIG. 1;

FIG. 3 shows a schematic block diagram of a concretization of the total depth map device in FIG. 2;

FIG. 4 shows a schematic representation of a visualization model as a result of the total depth map device of the preceding Figures;

FIG. 5 shows a camera section from a virtual camera in the visualization model in FIG. 4.

### DETAILED DESCRIPTION

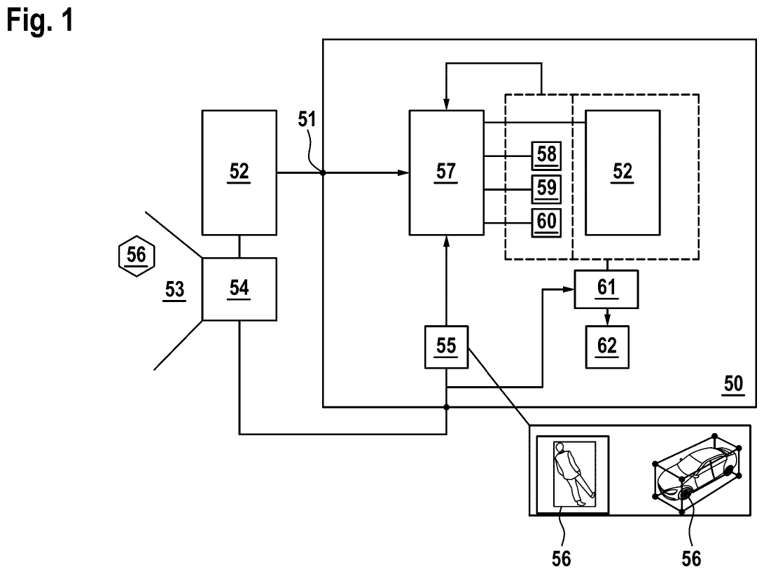

FIG. 1 shows a schematic block diagram of a total depth map arrangement 50 as a configuration example of the invention and for describing a configuration example of the method,

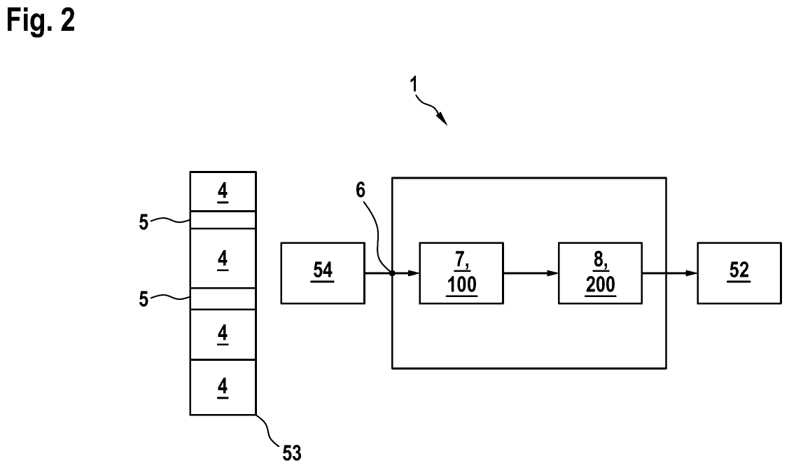

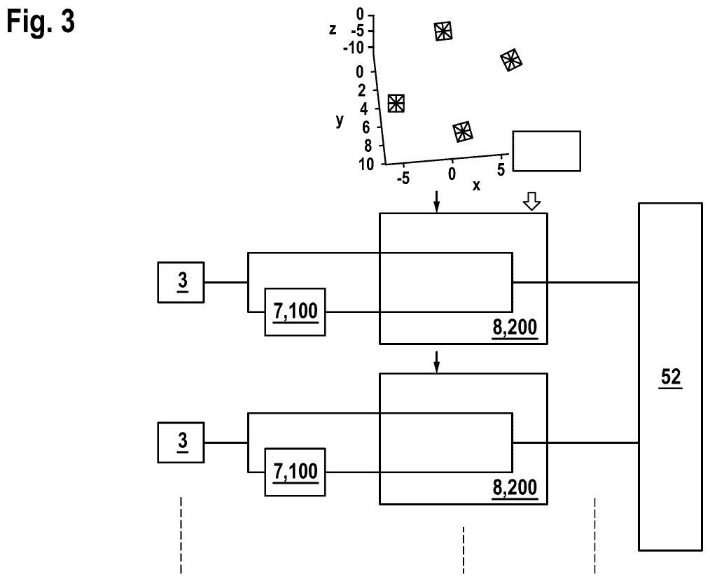

The total depth map arrangement 50 has an interface 51 for transferring a total depth map 52 from a monitoring area 53. The total depth map 52 may be provided in particular by the total depth map device of FIGS. 2 and 3. The monitoring area 53 is captured in particular with one or a plurality of monitoring cameras 54 and may form a single monitoring area 53, a contiguous monitoring area 54 or a segmented monitoring area 54.

The total depth map 52 represents the monitoring area 53, wherein depth information is entered instead of color values or the like. The total depth map may be configured, for example, as a 2D depth map, as a 3D point cloud, as a voxel grid or as a 2D elevation map or 3D mesh. In particular, the total depth map 52 is scaled, in particular metrically escalated.

The total depth map arrangement 50 has a detection module 55, wherein the detection module 55 is configured to detect an object 56, in particular a moving and/or mobile object 56, in the monitoring area 53. Detection is carried out, for example, using the images from the monitoring camera 54. Detection may be carried out using digital image processing or other algorithms.

The total depth map arrangement 50 has an evaluating and/or improving module 57, which is configured to evaluate and/or improve the total depth map 52 based on the detected object 56.

In order to improve and evaluate this total depth map 52, in particular in order to check its plausibility, observations are to be used. One possibility here is P3D detections of vehicles as objects 56 assuming a vehicle size (vehicle-specific via model, vehicle class or default size) as object information.

The evaluating and/or improving module 57 checks whether the detection—or temporal series of detections—matches the total depth map 52. If this is not the case, it is adjusted and thus improved. In the simplest case, the depth values below (and weighted in the vicinity of) the vehicle are corrected as object 56 to the corresponding height/distance. The correction is to be made in small steps. An extension of this is to evaluate the entire vehicle trajectory, since improving the total depth map 52 through the trajectory rules out the possibility of height jumps in the total depth map 52.

In the same way, person detections (2D and projected 3D, i.e. body pose) may be used for persons as object 56.

In general, several criteria may be used for estimation/correction: the size and orientation of a vehicle/person as object 56 allows direct conclusions to be drawn about the local plane normal in the total depth map 56. The condition that persons/vehicles as object 56 cannot change their size, orientation and speed instantaneously. The temporal consistency is therefore utilized here. Further features may be a speed estimate and its consistency over time for vehicles as object 56 and step consistency for people as object 56.

All these criteria may also be estimated implicitly by a neural network or a filter as a basis for the evaluating and improving module 57. In order to further improve the method, semantic segmentation may also be used as an option. This allows conclusions to be drawn about the meaning/semantics, for example. In this way, the total depth map 52 could also be augmented so that an improved semantic description is created in addition to the total depth map 52. This could, for example, describe the regions in which vehicles drive or only pedestrians move.

It may be very advantageous for the method to use a representation of the uncertainty in the corresponding regions in addition to the total depth map 52. In this way, regions in which no observations are available could be marked as uncertain and regions with contradictory detections could be marked as such and treated specially during the correction. This could be an uncertainty map 58 (Uncertainty-Map) and an inconsistency map 59 (Inconsistency-Map). The latter may be helpful in particular when repeated dynamic changes occur (opening and closing of a bridge). It may also be very advantageous to include (and correct/update) a representation of depth jumps or object boundaries as a limitation map 60. A correction, in particular an improvement of the total depth map 52 by an observed vehicle as object 56 should then ideally only have an influence up to the corresponding limitation. This limitation map 60 (edge map) could be initialized and/or corrected from observations, image edges, depth jumps or semantic segmentation.

Finally, it could be advantageous to run the method continuously. The result would be constantly updated when new observations (or a buffered set thereof) are available. At the same time, it could be useful for the additional maps (Edge, Uncertainty/Inconsistency, Semantic) to be marked as more uncertain over time if no new observations are available over a longer period of time. This is primarily intended to prevent the map from being classified as increasingly certain and, for example, structural changes from not being noticed.

In order to initialize the method, a total depth map 52 is generated (or, for example, a default map from level-based calibration is assumed). If a MonoDepth method is used, it could be useful to merge several, temporally offset MonoDepth results in order to exclude dynamic changes from the total depth map 52.

At the same time, potentially dynamic objects 56, such as vehicles, people, etc., could also be detected by semantic segmentation or object detection and the corresponding entries in the depth map, uncertainty map and inconsistency map could be initialized accordingly. The simplest way to concretely implement the method (filter) is in the form of a Kalman filter.

The total depth map arrangement 50 has a fusion module 61 for implementing a fusion step, wherein the fusion module 61 is configured to fuse the scaled total depth map 52 with image information of the monitoring sub-areas 4 or the monitoring area 53 in a common visualization model 11 of the monitoring area 53.

The visualization model 11 may subsequently be displayed in an output device 62. The visualization model 11 is configured in particular as a 3D model of the monitoring area 53, which is represented realistically by the enrichment with the image information and which may be displayed by a user or a surveillance personnel in any way, for example via a 3D screen, VR glasses or via one or more screens as output device 62, wherein any view may be displayed in the visualization model, for example by using virtual cameras.

The method generates a 3D representation of the scene in the monitoring area 53, which is much more intuitive to understand and also offers some new possibilities that a conventional representation does not allow or only allows with difficulty. The aim/result is that larger, connected camera networks are displayed in a single merged view.

When evaluating the total depth map 52, the uncertainty map 58, the inconsistency map 59 and/or the limitation map 60 are generated and displayed together in a display device 61. In this way, a user is informed about an evaluating status of the total depth map 52.

If the total depth map 52 is improved, the total depth map 52 is corrected directly, as described above. Alternatively or additionally, the uncertainty map 58, the inconsistency map 59 and/or the limitation map 60 are fed back into the evaluating and improving module 57 in order to improve the total depth map 52.

As already explained, the total depth map 52 may be configured as a two-dimensional map whose structure is similar to an underlying image and is thus also configured as a matrix, wherein the depth information is entered as pixels. However, it is also possible for the total depth map 52 to be configured as a 3D point cloud, wherein a plurality of depth maps are entered in a common coordinate system.

FIG. 2 shows a schematic block diagram of a total depth map generation device 1, which is configured to generate the total depth map 52, in particular as a 3D point cloud.

A plurality of monitoring cameras 54 are arranged in the monitoring area 53, which are shown together as a block in FIGS. 1 and 2. Each monitoring camera 54 captures an image of a monitoring sub-area 4, which is located in the field of view of the corresponding monitoring camera 3. The monitoring sub-areas 4 may be configured in a non-overlapping manner, as shown schematically in the lower region of the monitoring area 53. The monitoring sub-areas 4 may also overlap, so that overlapping regions 5 are formed, as shown schematically in the upper region of the monitoring area 2.

The total depth map generation device 1 has an interface 6 for transferring the images from the monitoring cameras 3. Optionally, the monitoring cameras 3 form a component of the total depth map generation device 1.

The total depth map generation device 1 has a depth recognition module 7, wherein the depth recognition module 7 is configured to create a respective depth map with depth information of the monitoring sub-area 4 assigned to the image in a depth recognition step 100 for each image of the monitoring cameras 3. The depth information in the respective depth maps is unscaled and/or configured as relative information.

The total depth map generation device 1 has a scaling module 8, wherein the scaling module 8 is configured to perform scaling of the depth maps of all monitoring cameras 3 in a or in the common coordinate system in a scaling step. In particular, the depth maps are brought into a common metric of the common coordinate system by the scaling module 8 and/or in the scaling step. In particular, the depth information of the different depth maps may be directly compared with each other. In principle, the scaled depth information may already be configured as absolute depth information, so that the depth information of the depth maps in a common coordinate system is configured as metric depth information. Alternatively, the scaled depth information may be configured as relative depth information, which is comparable in the common coordinate system, but is not expressed in absolute values, such as meters.

The representation of the depth maps in the common coordinate system forms the total depth map 52.

In principle, the depth recognition module 7 and the scaling module 8 may be configured as a common module, which performs the depth recognition step 100 and the scaling step 200, so that the scaled depth map is generated in a common step. As described above, this is a comparatively difficult and complex object for the corresponding evaluation methods.

Accordingly, it is proposed in the configuration example that first the depth recognition step 100 is carried out, for example based on the DPT described above, and subsequently the scaling is carried out based on at least one piece of scaling information. The scaling information has an information content that enables the depth maps to be scaled. In particular, it is information which is selected from intrinsic camera parameters of at least one monitoring camera, extrinsic camera parameters (in particular a location) of at least two monitoring cameras with overlapping monitoring sub-areas and/or overlap information of monitoring sub-areas. By introducing the scaling information as a-priori knowledge, the estimation of the scaled depth maps may be significantly improved, so that the method and the visualization device 1 are configured more robustly.

Overall, a completely different type of visualization is proposed, in which the method for monocular depth estimation (mono-depth) and (camera) calibration are combined.

FIG. 3 shows a configuration example of the invention in the form of a concretized embodiment of the total depth map device 1 in FIG. 2. Identical or corresponding components are provided with the same or corresponding reference signs.

FIG. 3 shows an exemplary implementation of the method for generating the total depth map 52 based on Vision Transformers for Dense Prediction (DPT), wherein several individual images (one image per monitoring camera 54) are used, to predict the non-metric depth and semantics and an intrinsic and extrinsic calibration determined in advance (only) based on the (here 24) individual images is used to rescale the depth maps, to determine the visual rays corresponding to the image points and to transfer the relative position of the monitoring cameras 54 and thus 3D point clouds into a common 3D view. Filtering was also carried out for improved visualization.

It should be noted that all the steps shown here (with the exception of determining the calibration) may be carried out independently for each monitoring camera 54, and therefore in parallel. Not shown are
live processing,
anonymization, a
more skillful fusion, which corrects (incorrect) depth jumps in overlapping views, for example, and
color correction, which corrects the color balance of the individual monitoring cameras 3.

In the configuration example in FIG. 3, images from 24 different monitoring cameras 3 were received. First, a calibration was determined, wherein corresponding points in the images were manually selected as scaling information. From this, the intrinsics (distortion, focal length) and extrinsics (relative position of the cameras to each other and ground plane) could be determined. The process of calibration could also be carried out in other ways (e.g. using known lens data and auto-calibration procedures).

First, DPT is used to generate both a depth map and a semantic segmentation in the depth recognition module 7. Ground-plane regions (here ‘Road’ class) are used from the semantic segmentation. It was assumed as scaling information that this is actually a (ground) plane. Alternative assumptions and methods are discussed in the next portion.

Based on the calibration, it may be predicted for each image point what depth/distance it has to have if it is a point on the ground plane. By comparing the corresponding ‘road’ regions of the depth map with this data, the scaling parameters, in this case two, may be determined, which make it possible to convert the depth map into metric depths/distances. Finally, the intrinsic calibration of the monitoring camera 3 is used once again to calculate (colored) 3D point clouds from the now metric depths.

In many methods for monocular depth estimation, depth jumps are ‘smoothed’, resulting in unsightly artifacts in the depth reconstruction. In order to filter these out, an edge detector was applied to the depth map here. A better way of filtering would not do this on the depth map (which represents the inverse depth), but on the actual depths (or a mixture or combination), since the method shown here becomes less sensitive at larger distances (the inverse depth values become very small, due to the higher distance, and so do the jumps). The choice and type of filtering may of course be chosen differently (see also next portion). Finally, the point clouds of the individual monitoring cameras 54 are combined. In the simplest case, these are simply displayed together and independently of each other. A small adjustment has been made here. Only the closest points of each monitoring camera 54 are displayed. This prevents gross misjudgments at a greater distance from overshadowing/overwriting good results from a local monitoring camera 54. It should be noted that this is only done based on the calibration information and therefore independently of the actual content (3D point clouds) of the other monitoring cameras 54. This means that completely parallel processing is still possible.

### Exemplary Results:

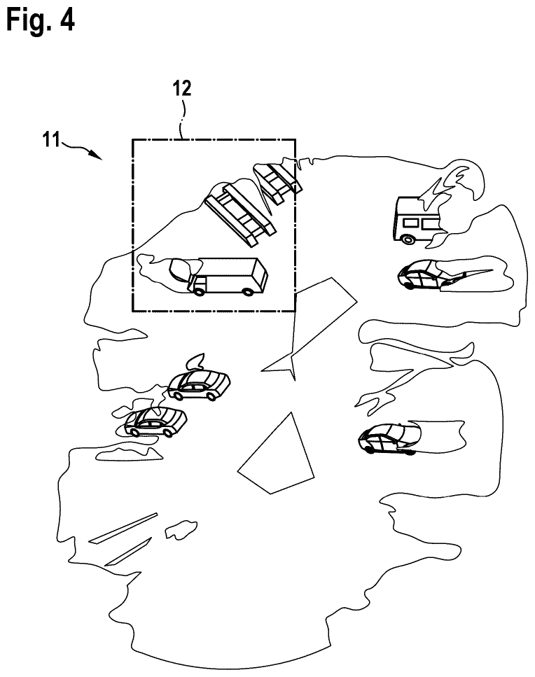

FIG. 4 shows the overall result of the 24 camera images as a visualization model 11. The image in FIG. 4 is a screenshot from the CloudCompare software, which may be used to display 3D point clouds. In some regions, in particular in those where many occlusions occur, the 3D reconstruction is currently not correct and somewhat difficult to interpret. It has to be said that DPT is a method from 2021 and better results can probably be expected with more up-to-date methods. In addition, the method was probably not trained on corresponding images from this (monitoring) region 53. However, if you move a virtual camera in the visualization model 11 as a point cloud visualization close to the real camera positions, the potential becomes more apparent.

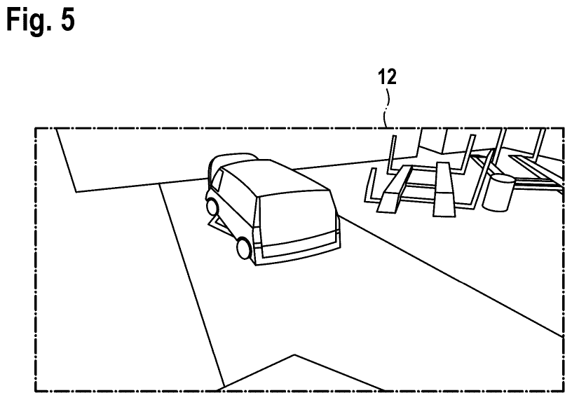

This can be clearly seen in FIG. 5, where a partial section 12 from FIG. 4 can be seen. Here, the images also have a similar color balance, which is why the transition between the two point clouds on the ground is invisible. The output device 62 may therefore be a screen that shows the partial section 12 as the field of view of a virtual camera.

### Alternative or Improved Representation:

In a further and improved form of representation, a simple anaglyph method is used to generate an actual 3D representation on a screen as output device 62 with the help of red-cyan color glasses. This representation helps significantly with the perception of the scene, since the content may be perceived directly and not only through texture differences and depth differences by (virtually) rotating/moving the camera/scene. An even better representation is achieved by using a VR headset, such as an Oculus Rift, since navigation (rotation and movement) and depth perception are significantly easier/more intuitive and a larger field of view is used. Another alternative is a 3D monitor as an output device 62 with appropriate glasses.

### Live View:

Only a static image/point cloud is described in the Figures. For an application, for example, (A) a current image/point cloud is generated every few minutes/seconds. Alternatively, this could also be done live (for every or almost every) image. Since this may be very computationally intensive (despite the possibility of independent processing for each monitoring camera 3), it could be advantageous to (B) perform the determination of the depths less frequently and only update the current texture (color image). The depth map could, for example, be a ‘background’ depth image generated from several depth maps that are offset in time so that moving objects are not included. Moving objects could also be displayed separately, for example, in the form of avatars or simple shapes (cylinders, cuboids) onto which the texture (color image) is projected. These objects are typically already detected in the monitoring camera 54 so that processing should be significantly faster.

### Anonymization:

If, as in the previous point (‘live view’), a background is created and people and vehicles etc. are drawn in separately, this is also a possible procedure for anonymization. Another step would be to replace the background texture (workshop in the case of the configuration example described) with a different one. Then the user or the surveillance personnel would only see the 3D structure and avatars or similar items and would not even know what is actually visible. This represents (almost) perfect anonymization.

### Tracking the Calibration

In moving (PTZ) monitoring cameras 54, the changing calibration over time has to be taken into account. If the change in calibration is known, this may be easily integrated. However, this requires the depth map to be recalculated. Alternatively, if a complete depth background map for a moving camera has been generated in advance as monitoring camera 54, no recalculation is necessary, only a corresponding conversion to the current field of view.

### Improved Fusion

In the method described, the 3D point clouds of each monitoring camera 54 are simply displayed together. It often happens that partial areas of camera views overlap and errors in the depth estimation or calibration lead to double structures. The same structure appears several times in different places. A method that recognizes and merges these structures could be used here. On the one hand, this could be an averaging of the depth and texture information at the corresponding location or a clever stitching.

### Color Correction (Color Balancing)

In FIG. 4, for example, it may be clearly seen on the floor surface that no color balancing was performed between the images. FIG. 5, on the other hand, clearly shows how well (in this case random) color balancing improves the illusion of a single result compared to a superposition of many individual results.

### Rescaling Method and Ground Plane Selection:

In the method described, the ground plane and automatic recognition of the corresponding image areas via semantic segmentation were used to introduce metric information into the ‘non-metric’ depth images. If there is actually a continuous ground plane, this has the advantage that it may be done fully automatically. Of course, this cannot be used in many situations. In addition, the reconstruction in the method described is metric, but not ‘in meters’. This means that lengths may be compared, but lengths in meters cannot be specified directly. For this, absolute scale information, such as the height of a person, the height of the monitoring camera 54 above the ground or something similar, has to be introduced.

Alternatively, metric information may be introduced, for example, via image correspondences in the overlapping area of two camera views/monitoring sub-areas 4. In this way, a depth could be determined via triangulation (as with classic stereo methods). The correct scale could, for example, come from the known clearance between two monitoring cameras 54 or the camera height. Alternatively, monitoring cameras 54, such as the Flexidome Multi from Bosch, could utilize the fact that the monitoring cameras 54 can only be moved on a ring whose radius is known. Alternatively, the correct scale may also be determined by a few direct clearances measurements, e.g. with a laser distance meter.

A suitable ground plane or other plane could also be selected using methods such as Segment-Anything, for example, where the operator may select appropriate regions with just a few mouse clicks.

### Removing Implausible Depth Measurements:

As shown in the method, implausible depth measurements may be discarded by filtering. This may be done using simple methods. However, it may also be useful, for example, to recognize whether there are meaningful structures in the overlapping area of several monitoring cameras (see also ‘Improved fusion’). Finally, timestamps should also be (automatically) removed, since no meaningful depth can be attributed to them.

### Parallel Processing

As mentioned above, depending on the application, processing may be completely parallel except for visualization. This means, for example, that individual surveillance cameras may also generate 3 3D point clouds or a depth map in a suitable form and send them to a central server or alarm monitoring center. See also ‘Internal 3D representation’ for the amount of data that needs to be transferred.

### Rectification:

Many MonoDepth methods, such as DPT, are not designed for image data with significant distortion, as is often the case. Therefore, the images are first rectified, which brings significant improvements. A processing step directly at the beginning of the method may therefore also be to rectify the image or even to split it into several rectified images and then merge the depth results of the individual images again. This may be particularly useful with very wide-angle cameras (e.g. fisheye).

### Internal 3D Representation:

The representation as a point cloud (several million individual points) of the total depth map 52 allows a high, but unnecessary, level of detail. Alternatively, a 3D mesh could also be used here, which allows the texture to be rendered very quickly. This representation of the results is common in computer games etc. and is quick to process and requires less storage space or transmission bandwidth.

### See-Through:

The combination of 3D information and multiple views also allows functions such as see-through, in which, for example, people who are obscured in the current (virtual) view are displayed schematically.

### Improved Tracking:

The 3D information allows improved tracking of people, since it is known that tracked people will disappear behind a car, for example, if they continue their walking movement.

### Other Scenarios:

In the method described, an example with many monitoring cameras and a large overlapping region was shown. In essence, however, the method does not require this. Another scenario would be, for example, monitoring the fence of a substation. Here, many monitoring cameras 54 are typically used, but with little or no overlapping region. Here, for example, a satellite or topographic map could be enriched with 3D point clouds/meshes. The display could be as described above.

1. A method for evaluating and/or improving a total depth map (52) of a monitoring area (53), the method comprising:
providing, via a computer, a total depth map (52) of the monitoring area (53),
detecting, via the computer, at least one object (56) in the monitoring area (53), and
evaluating and/or improving, via the computer, the total depth map (52) based on the detected object (56).

2. The method according to claim 1, wherein the detected object (56) is recognized, wherein an object size and/or object orientation is estimated as object information based on the recognized object (56), wherein the total depth map (52) is evaluated and/or improved based on the object information.

3. The method according to claim 1, wherein the detected object (56) is recognized as a person, wherein person information is estimated, wherein the total depth map (52) is evaluated and/or improved based on the person information.

4. The method according to claim 1, wherein the detected object (56) is recognized as a vehicle, wherein vehicle information is estimated based on the recognized vehicle, wherein the total depth map (52) is evaluated and/or improved based on the vehicle information.

5. The method according to claim 1, wherein a polyhedron representing the detected object (56) is derived for the detected object, wherein the total depth map (52) is evaluated and/or improved based on the polyhedron.

6. The method according to claim 1, wherein a trajectory of the detected object (56) is detected in the monitoring area (53), wherein the total depth map (52) is evaluated and/or improved based on the detected trajectory of the object (56).

7. The method according to claim 1, wherein an uncertainty map (58) is generated as an evaluation, wherein evaluation results of the total depth map (52) based on the detected object (56) are displayed in the uncertainty map (58).

8. The method according to claim 1, wherein an inconsistency map (59) is generated as an evaluation, wherein inconsistent regions of the total depth map (52) based on the detected object (56) are displayed in the inconsistency map (59).

9. The method according to claim 1, wherein a limitation map (60) is generated as an evaluation, wherein height jumps and/or mechanical limitations of the total depth map (52) are displayed in the limitation map (60).

10. The method according to claim 1, wherein, in a fusion step, the total depth map (52) is fused with image information of images of the monitoring area (53) in a visualization model (11).

11. The method according to claim 1, wherein a plurality of monitoring cameras (54) is arranged in the monitoring area (53) in order to provide the total depth map (52), wherein each monitoring camera (54) can capture an image from a monitoring sub-area (4) of the respective monitoring camera (54),
wherein, in a depth recognition step (100), a depth map with depth information of the monitoring sub-area (4) is created for the images of the monitoring cameras (54),
wherein, in a scaling step (200), a scaling of the depth maps for a common coordinate system of the monitoring sub-areas (4) is performed in order to form the total depth map (52).

12. A total depth map arrangement (1) comprising:
an interface (51) configured to transfer a total depth map (52) of a monitoring area (53),
a detection module (55) configured to detect at least one object (56) in the monitoring area, and
an evaluating and/or improving module (57) configured to evaluate and/or improve the total depth map (52) based on the detected object (56).

13. A non-transitory, computer readable medium comprising instructions that when executed by a computer cause the computer to
provide a total depth map (52) of a monitoring area (53),
detect at least one object (56) in the monitoring area (53), and
evaluate and/or improve the total depth map (52) based on the detected object (56).
